(19) United States
(12) Patent Application Publication
(10) Pub. No.: US 2011/0002583 A1
(43) Pub. Date: Jan. 6, 2011

(54) OPTICAL DEVICE

(75) Inventors: Oh-Kee Kwon, Daejeon (KR); Chul-Wook Lee, Daejeon (KR); Dong-Hun Lee, Daejeon (KR); Jong-Hoi Kim, Daejeon (KR); Eundeok Sim, Daejeon (KR); Yongsoon Baek, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/764,786

(22) Filed: Apr. 21, 2010

(30) Foreign Application Priority Data
Jul. 2, 2009 (KR) 10-2009-0060168

(51) Int. Cl. G02B 6/28; G02B 6/34

(52) U.S. Cl. 385/24; 385/37

(57) ABSTRACT

Provided is an optical device. The optical device includes a multiplexer/demultiplexer, a multimode interference (MMI) coupler, a first waveguide, and second waveguides. The multiplexer/demultiplexer splits optical signals having a plurality of channels and received through a first port according to their wavelength to provide the split optical signals to second ports, or providing input optical signals having wavelengths difference from each other and received through the second ports to the first port. The multimode interference (MMI) coupler is connected to the first port. The first waveguide is connected to the MMI coupler. The second waveguides are connected to the second ports. The MMI coupler has a width decreasing toward the multiplexer/demultiplexer.

### CROSS-REFERENCE TO RELATED APPLICATIONS

This U.S. non-provisional patent application claims priority under 35 U.S.C. §119 of Korean Patent Application No. 10-2009-0060168, filed on Jul. 2, 2009, the entire contents of which are hereby incorporated by reference.

### BACKGROUND

The present disclosure herein relates to an optical device that is used for broadband transport networks.

With the development of information communication technologies, technologies for realizing advanced broadband transport networks such as a wavelength division multiplexing (WDM) method are being rapidly developed to process a large amount of information. In the WDM method, a multiplexer combines input optical signals, each of which has a different wavelength, received through a plurality of input waveguides to provide the combined optical signals to one output waveguide. A demultiplexer splits optical signals having a plurality of channels received through one input waveguide into a plurality of single wavelength optical signals according to their wavelength to provide the split optical signals to an output waveguide. The multiplexer is a key device for an optical communication system employing WDM. The multiplexer was developed from an initial bulk-type multiplexer to a multiplexer based on a waveguide having a size of several centimeters to several millimeters.

### SUMMARY OF THE INVENTIVE CONCEPT

Embodiments of the inventive concept provide an optical device including a multimode interference coupler having a box-like spectral response characteristic and a multiplexer.

Embodiments of the inventive concept provide optical devices include: a multiplexer/demultiplexer splitting optical signals having a plurality of channels and received through a first port according to their wavelength to provide the split optical signals to second ports, or providing input optical signals having wavelengths difference from each other and received through the second ports to the first port; a multimode interference (MMI) coupler connected to the first port; a first waveguide connected to the MMI coupler; and second waveguides connected to the second ports. The MMI coupler has a width decreasing toward the multiplexer/demultiplexer.

In some embodiments, the first waveguide may include a first tapered part having a width increasing toward the MMI coupler.

In other embodiments, the second waveguide may include a second tapered part having a width increasing toward the multiplexer/demultiplexer.

In still other embodiments, the MMI coupler may be connected to the first port in a region in which a second multimode pattern is formed.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the figures:

FIGS. 1 through 4 are views of an optical device according to embodiments of the inventive concept;

FIGS. 5A through 5F are sectional views illustrating a structure of a mode interference coupler;

FIGS. 6A through 6C are views of a mode interference coupler and a first waveguide according to an embodiment of the inventive concept;

FIGS. 7A and 7B are computer simulation results illustrating characteristics at points a, b, c, and d of FIG. 6C;

FIGS. 8A through 8C are views of a mode interference coupler and a waveguide according to another embodiment of the inventive concept; and

FIGS. 9A and 9B are computer simulation results illustrating characteristics at points a, b, c, and d of FIG. 8C.

### DETAILED DESCRIPTION OF THE EMBODIMENTS

Preferred embodiments of the inventive concept will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the drawings, the thicknesses of layers and regions are exaggerated for clarity. Like reference numerals in the drawings denote like elements.

It will be understood that a multiplexer/demultiplexer described in embodiments of the inventive concept include a general multiplexer as well as a demultiplexer. Since the multiplexer/demultiplexer serves as a channel filter in an operable wavelength region, it is required to have ideal box-like spectral response characteristics.

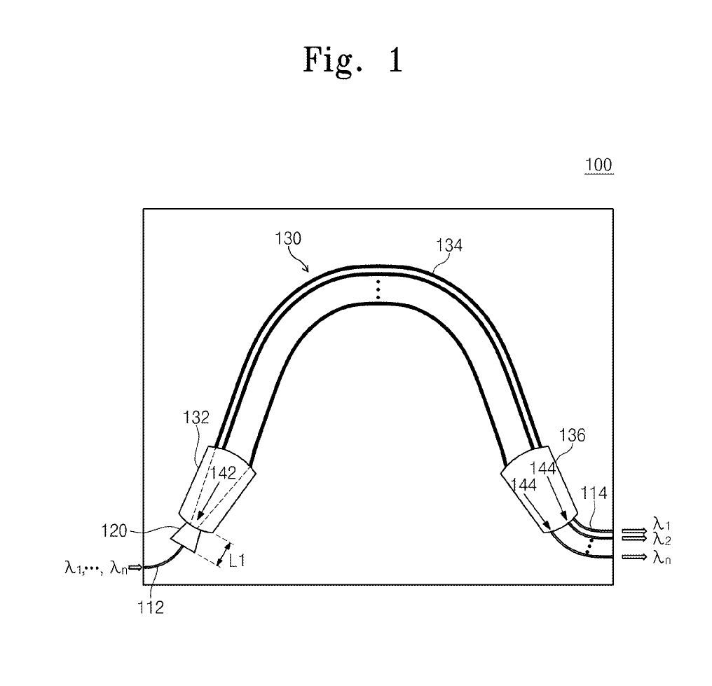

FIGS. 1 through 4 are views of an optical device according to embodiments of the inventive concept.

Referring to FIG. 1, an optical device 100 includes a multiplexer/demultiplexer 130, a multimode interference (MMI) coupler 120, a first waveguide 112, and second waveguides 114. The multiplexer/demultiplexer 130 splits optical signals (λ₁, . . . , λ_{N}) having a plurality of channels and received through one end thereof, i.e., a first port 142 according to their wavelength to provide the split optical signals to the other end thereof, i.e., second ports 144. The MMI coupler 120 is connected to the first port 142 of the multiplexer/demultiplexer 130. The first waveguide 112 is connected to the MMI coupler 120. The second waveguides 144 are connected to the second ports 144 of the multiplexer/demultiplexer 130.

The multiplexer/demultiplexer 130 may include a first arm 132, an arrayed waveguide grating (AWG) 134, and a second arm 136. The first arm 132 may include the first port 142. The second arm 136 may include the second ports 144. The first arm 132 of the multiplexer/demultiplexer 130 may radiate (beam spread) signals applied to the first port 142 through the first waveguide 112 and the MMI coupler 120. The radiated beam may be coupled to the AWG 134. Then, the radiated beams may be focused on the second arm 136 and emitted through the second ports 144 and the second waveguides 114. On the other hand, the multiplexer/demultiplexer 130 may provide input optical signals different from each other received through the second ports 144 to the first port 142. The AWG 134 may shift phases of the beams coupled thereto. The phase shift may be performed through a length of a waveguide. The AWG 134 may provide constructive interference according to their wavelength.

The MMI coupler 120 is disposed between the first waveguide 112 and the multiplexer/demultiplexer 130. The MMI coupler 120 may be connected to the first port 142 of the multiplexer/demultiplexer 130. The MMI coupler 120 may have a vertical structure equal to that of the first waveguide 112. The MMI coupler 120 may have a width decreasing toward the multiplexer/demultiplexer 130. That is, the MMI coupler 120 may have a width gradually narrower toward the first port 142. When the width of the MMI coupler 120 is tapered, a width and spatial period of an interference pattern within the MMI coupler 120 may gradually become narrow. Thus, the interference pattern may have various widths according to a length L1 of the MMI coupler 120. Also, the MMI coupler 120 and the multiplexer/demultiplexer 130 may provide a flat-top characteristic or a box-like spectral response characteristic according to the length L1 of the MMI coupler 120. As a result, waveguide-mode dependence of the first waveguide 112 may be reduced. In addition, a flat transmission width may be realized without modifying a structure of the multiplexer/demultiplexer 130. The MMI coupler 120 may have a structure having a high refractive index or may provide the box-like spectral response characteristic in a structure in which the first waveguide 112 has a narrow width. The MMI coupler 120 may be integrated with the multiplexer/demultiplexer 130 or the first waveguide 112.

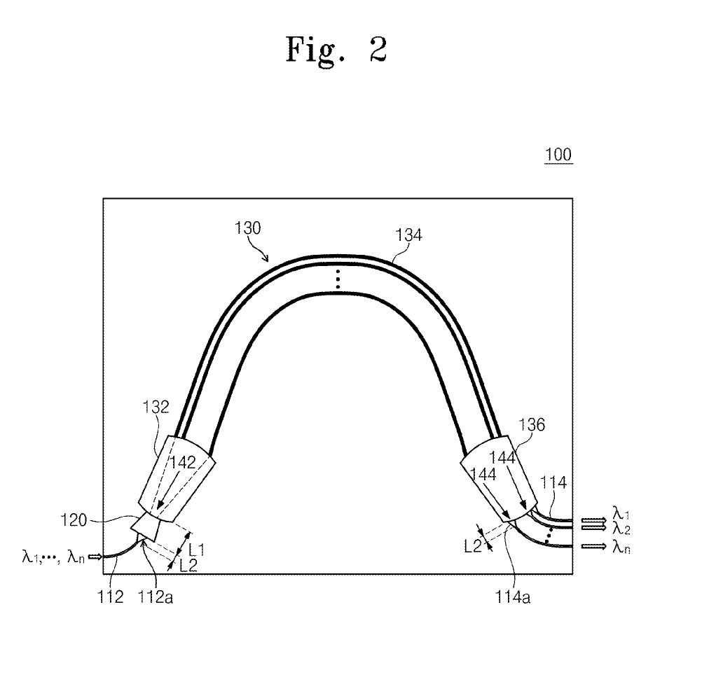

FIG. 2 is a view of an optical device according to another embodiment of the inventive concept. Components which correspond to those already described above with reference to FIG. 1 will be omitted.

Referring to FIG. 2, the first waveguide 112 may include a first tapered part 112a. The first tapered part 112a may be connected to the MMI coupler 120. The first tapered part 112a may have a width increasing toward the MMI coupler 120. The first tapered part 112a may have a maximal width less than that of the MMI coupler 120. The first tapered part 112a may change an interference characteristic (a period of an interference pattern) of the MMI coupler 120. As the first tapered part 120 increases in width, the interference pattern may relatively increase in period. Thus, in spite of a structural modification occurring during a manufacturing process, a stably flat transmission characteristic may be obtained.

The respective second waveguides 114 may include a second tapered part 114a. The second tapered part 114a may be connected to the second arm 136. The second tapered part 114a may have a width increasing toward the second arm 136. As the second tapered part 114a increases in width, a transmission bandwidth may increase. The first tapered pat 112a may have a length similar to that L2 of the second tapered part 114a. The first tapered part 112a and the second tapered part 114a may have the lengths less than that L1 of the MMI coupler 120.

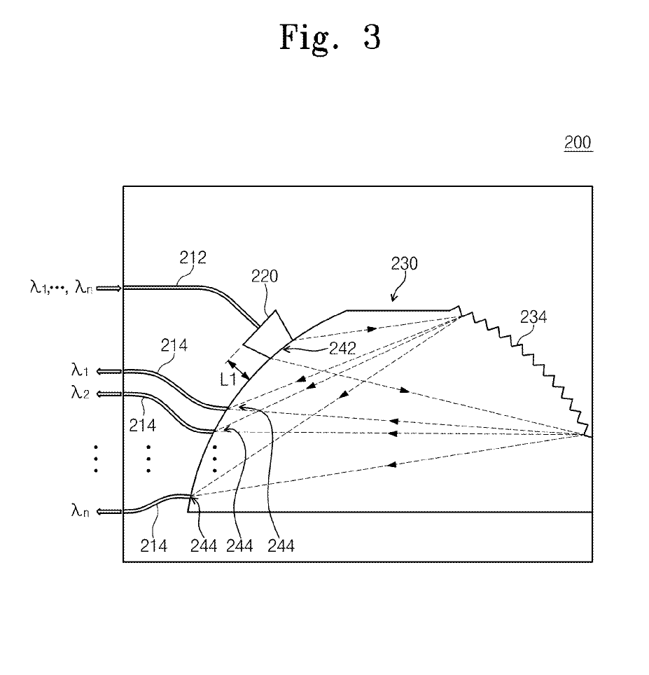

FIG. 3 is a view of an optical device according to another embodiment of the inventive concept.

Referring to FIG. 3, an optical device 200 includes a multiplexer/demultiplexer 230, an MMI coupler 220, a first waveguide 220, and second waveguides 214. The multiplexer/demultiplexer 230 splits optical signals (λ₁, . . . , λ_{N}) having a plurality of channels received through a first port 242 according to their wavelength to provide the split optical signals to second ports 244. The multimode interference (MMI) coupler 220 is connected to the first port 242 of the multiplexer/demultiplexer 230. The first waveguide 212 is connected to the MMI coupler 220. The second waveguides 244 are connected to the second ports 244 of the multiplexer/demultiplexer 230.

The multiplexer/demultiplexer 230 may include a concave grating (CG) 234. The multiplexer/demultiplexer 230 may provide signals having wavelengths different from each other and inputted into the first port 242 to spatially different positions with output signals according to their wavelength. The signal applied to the first waveguide 212 may be radiated from the first port 242 through the MMI coupler 220. The radiated beams may be reflected by the CG 234. The reflected beams are coupled to the second waveguides 214, and then emitted. On the other hand, the multiplexer/demultiplexer 230 may provide optical signal having wavelengths different from each other and received through the second ports 244 to the first port 242. The CG 234 may shift phases of the beams incident into the CG 234 to constructively interfere according to their wavelengths through a CG period.

The MMI coupler 220 may be connected to the first port 242 of the multiplexer/demultiplexer 230. The MMI coupler 220 may have a width decreasing toward the multiplexer/demultiplexer 230. That is, the MMI coupler 220 may have a width gradually narrower toward the first port 242. When the width of the MMI coupler 220 is tapered, a width and spatial period of an interference pattern within the MMI coupler 220 may gradually become narrow. Thus, the interference pattern may have various widths according to a length L1 of the MMI coupler 220. Also, the MMI coupler 220 and the multiplexer/demultiplexer 230 may provide a flat-top characteristic or a box-like spectral response characteristic according to the length L1 of the MMI coupler 220. As a result, waveguide-mode dependence of the first waveguide 212 may be reduced. In addition, a flat transmission width may be realized without modifying a structure of the multiplexer/demultiplexer 230. The MMI coupler 220 may have a structure having a high refractive index or may provide the box-like spectral response characteristic in a structure in which the first waveguide 212 has a narrow width. The MMI coupler 220 may be integrated with the multiplexer/demultiplexer 230 or the first waveguide 212.

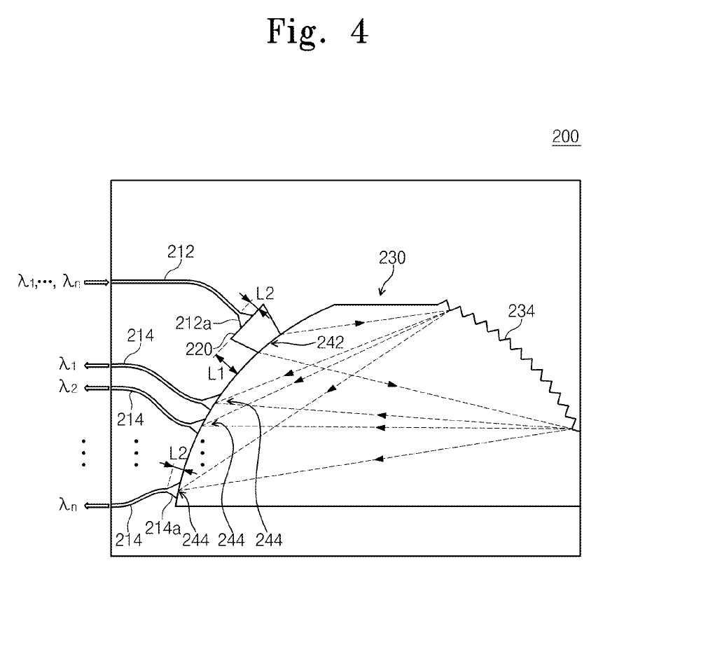

FIG. 4 is a view of an optical device according to another embodiment of the inventive concept. Components which correspond to those already described above with reference to FIG. 3 will be omitted.

Referring to FIG. 4, the first waveguide 212 may include a first tapered part 212a. The first tapered part 212a may be connected to the MMI coupler 220. The first tapered part 212a may have a width increasing toward the MMI coupler 220. The first tapered part 112a may have a maximal width less than that of the MMI coupler 220. The first tapered part 212a may change an interference characteristic (a period of an interference pattern) of the MMI coupler 220. As the first tapered part 220 increases in width, the interference pattern may relatively increase in period. Thus, in spite of a structural modification occurring during a manufacturing process, a stably flat transmission characteristic may be obtained.

The respective second waveguides 214 may include a second tapered part 214a. The second tapered part 214a may be connected to the respective second ports 244 of the multiplexer/demultiplexer 230. As the second tapered part 214a increases in width, a transmission bandwidth may increase.

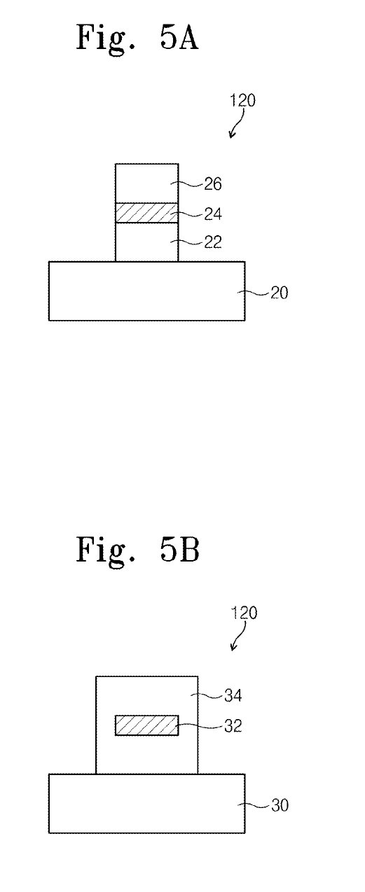

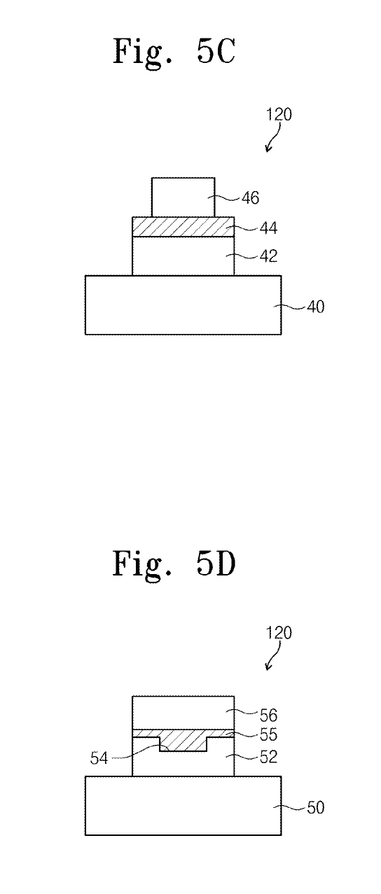

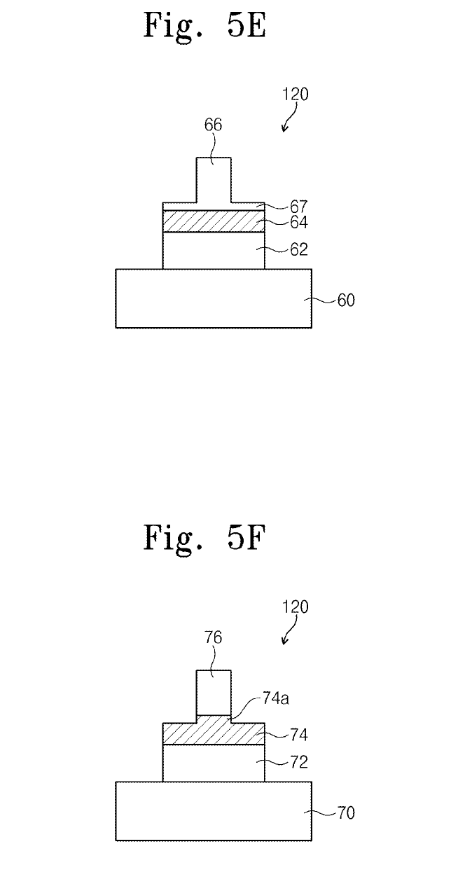

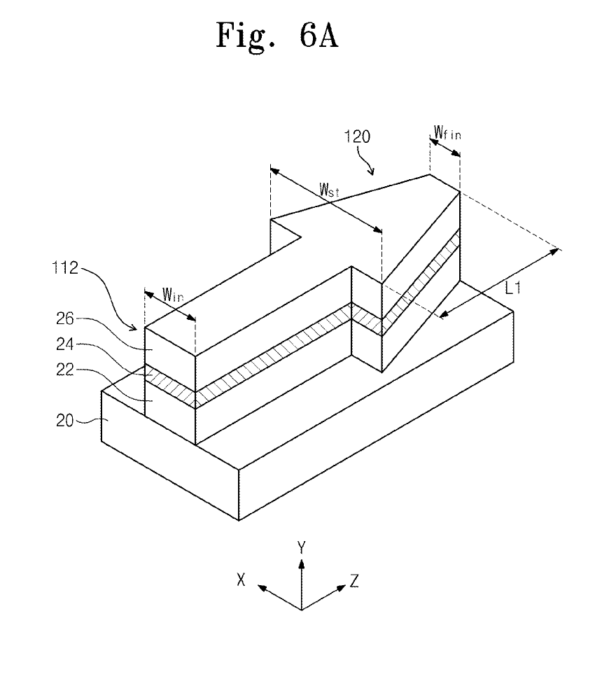

Hereinafter, structures of an MMI coupler according to an embodiment of the inventive concept will be described with reference to FIGS. 5A through 5F.

Referring to FIG. 5A, an MMI coupler may have a deep ridge waveguide (deep RWG) structure. The MMI coupler may be integrated with a first waveguide. The MMI coupler and the first waveguide may include a lower clad layer 22, a core, 24, and an upper clad layer 26, which are sequentially stacked on a substrate 20. Lateral surfaces of the lower clad layer 22, the core 24, and the upper clad layer 26 may be aligned with each other.

The substrate 20 may be formed of silica, silicon, amorphous silicon, InP, GaAs, LiTaO₃, or polymer. When the substrate 20 is formed of InP, the core 24 may be formed of InGaAsP. The core 24 may have a band gap of about 1.05 um. The upper clad layer 26 and the lower clad layer 22 may have thicknesses of about 1 um, respectively.

Referring to FIG. 5B, the MMI coupler may have a buried heterosturcture (BH). The MMI coupler may be integrated with the first waveguide. The MMI coupler and the first waveguide may include a substrate 30, a core 32, and a clad layer 34. The core 32 and the clad layer 34 may be disposed on the substrate 30. The clad layer 34 may surround the core 32.

Referring to FIG. 5C, the MMI coupler may have a shallow RWG structure. The MMI coupler and the first waveguide may include a lower clad layer 42, a core 44, and an upper clad layer 46, which are sequentially stacked on a substrate 40. Lateral surfaces of the core 42 and the lower clad layer 44 may be aligned with each other. The upper clad layer 46 may be disposed on the core 44. The upper clad layer may have a width less than that of the core 44.

Referring to FIG. 5D, the MMI coupler may have a rib WG structure. The MMI coupler and the first waveguide may include a lower clad layer 52, a core 55, and an upper clad layer 56, which are sequentially stacked on a substrate 50. Lateral surfaces of the core 55, the lower clad layer 52, and the upper clad layer 56 may be aligned with each other. The upper clad layer 56 may be disposed on the core 55. The lower clad layer 52 may include a trench defined in a central region thereof. The core 55 may fill the trench 54 and be disposed on the lower clad layer 52.

Referring to FIG. 5E, the MMI coupler and the first waveguide may include a lower clad layer 62, a core 64, and an upper clad layer 67, which are sequentially stacked on a substrate 60. Lateral surfaces of the lower clad layer 62, the core 64, and the upper clad layer 67 may be aligned with each other. The upper clad layer 67 may be disposed on the core 64. The upper clad layer 67 may include a protrusion 66 in a central region thereof.

Referring to FIG. 5F, the MMI coupler and the first waveguide may include a lower clad layer 72, a core 74, and an upper clad layer 76, which are sequentially stacked a substrate 70. Lateral surfaces of the core 74 and the lower clad layer 72 may be aligned with each other. The core 74 may include a core protrusion 74a in a central region thereof. The upper clad layer 76 may be disposed on the core protrusion 74a. Lateral surfaces of the core protrusion 74a and the upper clad layer 76 may be aligned with each other.

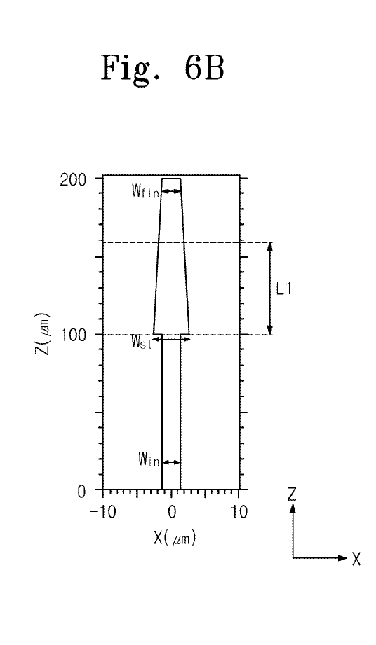

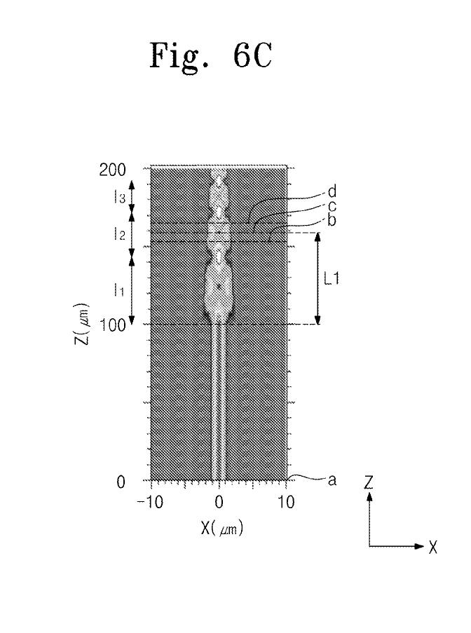

Hereinafter, waveguide characteristics of an MMI coupler 120 and a first waveguide 112 according to an embodiment of the inventive concept will be described with reference to FIGS. 6A through 6C. FIG. 6A is a perspective view of the MMI coupler 120 and the first waveguide 112. FIG. 6B is a plan view illustrating the MMI coupler 120 and the first waveguide 112 of FIG. 6A. FIG. 6C is a computer simulation result illustrating an interference pattern of the MMI coupler 120 and the first waveguide 112 of FIG. 6A.

Referring to FIG. 6A through 6C, the MMI coupler 120 and the first waveguide 112 may have a deep RWG structure. The MMI coupler 120 and the first waveguide 112 may include a lower clad layer 22, a core 24, and an upper clad layer 26, which are sequentially stacked on a substrate 20. Lateral surfaces of the lower clad layer 22, the core 24, and the upper clad layer 26 may be aligned with each other.

The substrate 20 may include an InP substrate. The core 24 may be formed of InGaAsP having a band gap of about 1.05 um. The core 24 may have a thickness of about 0.5 um. The upper clad layer may have a thickness of about 1 um. The first waveguide 112 may have a width Win of about 2.5 um.

The MMI coupler 120 has an input width Wst greater than an output width Wfin thereof. When a width of the MMI coupler 120 is tapered, a width of an interference pattern within the MMI coupler 120 gradually becomes narrow, and a period of the interference pattern gradually becomes short during beam propagation. The interference pattern may have various widths according to a length L1 of the MMI coupler 120.

In a structure used for the computer simulation, a width Win of the first waveguide is about 2.5 um, an input width Wst of the MMI coupler is about 5 um, and an output width Wfin of MMI coupler is about 2.5 um. Lengths at points a, b, c, and d of the MMI coupler are defined as follows: z=0 um, z=154 um, z=159 um, and z=162 um, respectively. The points b, c, and d are selected within a region (1₂˜59 um) in which a second multimode pattern is formed. A more improved flat transmission characteristic is obtained in the region in which the second multimode pattern is formed. Thus, the MMI coupler may be connected to a first port in the region in which the second multimode pattern is formed. The flat transmission characteristic is obtained also in a region 1₁ or 1₃ in which a first or third multimode pattern is formed. However, it is difficult to obtain a desired flat transmission characteristic in the region 1₁ in which the first multimode pattern is formed because the first multimode pattern has a very wide width. Also, there is a limitation that a design margin is low in the region 1₃ in which the third multimode pattern is formed because the third multimode pattern has a narrow width.

The MMI coupler 120 may have an input width Wst of about 5 um. When the MMI coupler 120 has an input width Wst of less than about 3 um, it is difficult to cause actually good MMI. Also, when the MMI coupler 120 has an input width Wst of greater than about 10 um, it is difficult to realize a desired MMI because the MMI coupler 120 has a short mode change period. When the input width Wst the MMI coupler 120 increases, there is a limitation that a distance between modes formed in the MMI coupler 120 is widened to increase a ripple.

In the tapered MMI coupler 120, the mode width formed in the MMI coupler 120 may be varied in a longitudinal direction (z-axis direction). Thus, a length corresponding to a width of the MMI coupler 120 that may obtain the flat transmission characteristic may be adequately selected. In the optical device according to an embodiment, a flat transmission band width may be realized without modifying a structure of a multiplexer.

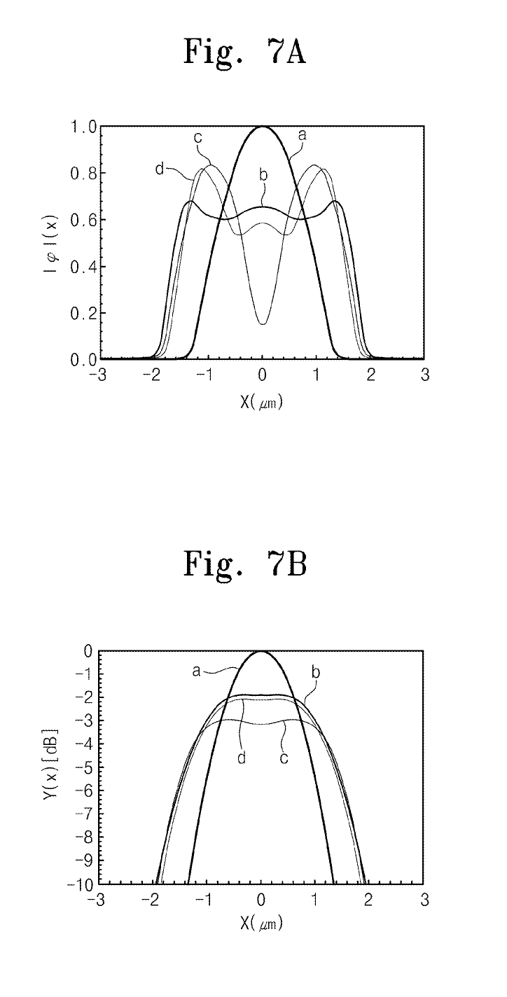

FIGS. 7A and 7B are computer simulation results illustrating characteristics at points a, b, c, and d of FIG. 6C. FIG. 7A illustrates an absolute value Φ_{a, b, c, d}(X) of an optical intensity in a transverse direction at the points a, b, c, and d. FIG. 7B illustrates transfer characteristics Y(x) at an output point of a multiplexer according to an MMI coupler having lengths at the points a, b, c, and d.

Referring to FIGS. 7A and 7B, in a structure used for the computer simulation, a width Win of the first waveguide is about 2.5 um, an input width Wst of the MMI coupler is about 5 um, and an output width Wfin of the MMI coupler is about 2.5 um. Lengths at points a, b, c, and d of the MMI coupler are defined as follows: z=0 um, z=154 um, z=159 um, and z=162 um, respectively. The points b, c, and d are selected within a region (1₂˜59 um) in which a second multimode pattern is formed.

The transfer characteristic Y(x) may be defined may be defined as the following Equation (1).

$${Y}_{a , b , c , d} ( x ) [ dB ] = 10 {log ( {\int }_{- ∞}^{+ ∞} {φ}_{a , b , c , d}^{*} ( u - x ) d u )}^{2} \qquad ( 1 )$$

The transfer characteristic Y(x) at the point c shown a peak value of about −3 dB and a ripple of about 0.2 dB. The transfer characteristic Y(x) at the points b and d shown a flat-top characteristic of a peak value of about −2 dB. With respect to the point c, the transfer characteristic Y(x) within about ±4 um in a z-direction shown a fluctuation (about 1 dB) between about −3 dB and about −2 dB.

In the transfer characteristic Y(x) according to an embodiment of the inventive concept, it was seen that a high transmission ratio (−3.2 dB→−2 dB), a low ripple (3 dB→0.2 dB), a less fluctuation (0.28 dB→1 dB) are obtained when compared to a structure in which an MMI coupler is not tapered under the same conditions as the above-described conditions. The flat transmission characteristic is obtained also in a region 1₁ or 1₃ in which a first or third multimode pattern is formed. As the multimode pattern increases in order, the flat transmission width gradually becomes narrow because the width of the MMI coupler gradually becomes narrow. Thus, the flat-top peak increases, and also, transmission characteristic fluctuation according to a change of the length increases.

When the MMI coupler 120 has a width of less than about 5 um, it is difficult to cause actually good MMI. Also, it is difficult to realize a desired MMI because the MMI coupler 120 has a short mode change period. In addition, there is a limitation that a distance between modes formed in the MMI coupler 120 may be widened to increase the ripple.

According to a modified embodiment of the inventive concept, a structure of the MMI coupler 120 is not limited to the above-described structure. The input width Wst and the output width Wfin of the MMI coupler 120 may be adjusted to adjust a width change of the interference pattern. In the structure of the MMI coupler 120, the regions in which the interference pattern occurs may be variously selected to obtain flat band characteristics. The structure of the MMI coupler 120 may include a structure symmetrically tapered in a width direction and a structure asymmetrically tapered in a width direction. An inclination of the MMI coupler 120 may be linear or non-linear.

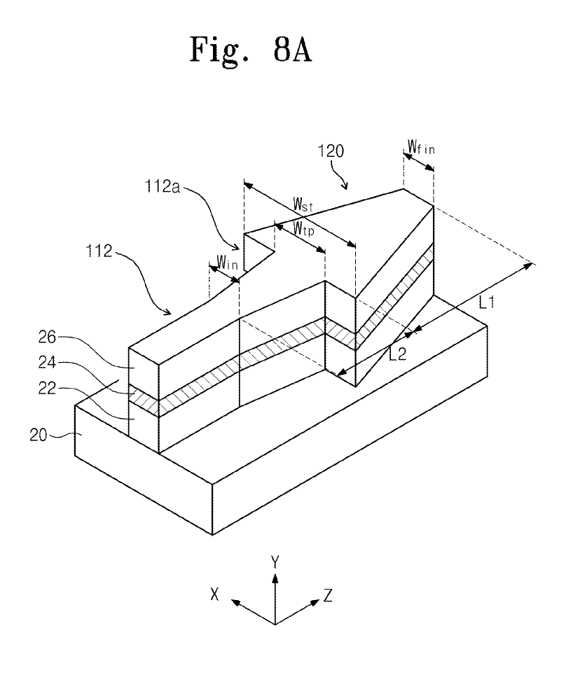

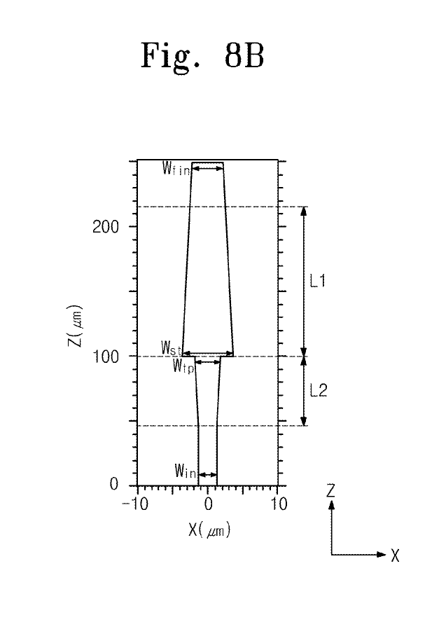

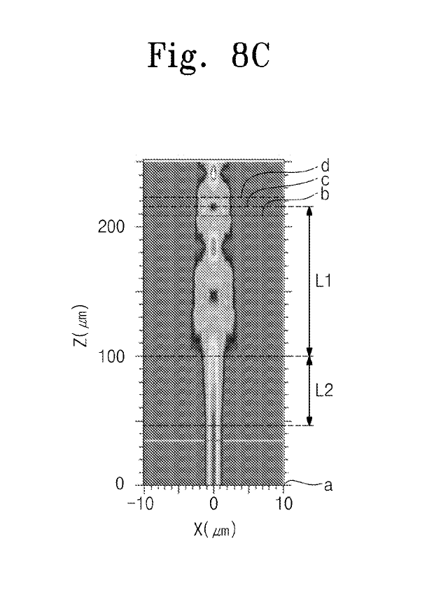

Hereinafter, waveguide characteristics of an MMI coupler, a first tapered part, and a first waveguide according to another embodiment of the inventive concept will be described with reference to FIGS. 8A through 8C. FIG. 8A is a perspective view of the MMI coupler, the first tapered part, and the first waveguide. FIG. 8B is a plan view illustrating the MMI coupler, the first tapered part, and the first waveguide of FIG. 8A. FIG. 8C is a computer simulation result illustrating an interference pattern of the MMI coupler, the first tapered part, and the first waveguide of FIG. 8A.

A MMI coupler 120 and a first waveguide 112 may have a deep RWG structure. The MMI coupler 120 and the first waveguide 112 may include a lower clad layer 22, a core 24, and an upper clad layer 26, which are sequentially stacked on a substrate 20. Lateral surfaces of the lower clad layer 22, the core 24, and the upper clad layer 26 may be aligned with each other.

The first waveguide 112 may include a first tapered part 112a. The MMI coupler 120 has a length L1, and the first tapered part 112a has a length L2.

The substrate 20 may include an InP substrate. The core 24 may be formed of InGaAsP having a band gap of about 1.05 um. The core 24 may have a thickness of about 0.5 um. The upper clad layer may have a thickness of about 1 um. The first waveguide 112 may have a width Win of about 2.5 um. The first tapered part 112a may have an input width Win of about 0.5 um. The first tapered part 112a may have an output width Wtp of about 3.5 um.

The MMI coupler 120 has an input width Wst greater than an output width Wfin thereof. When a width of the MMI coupler 120 is tapered, a width and period of an interference pattern within the MMI coupler 120 gradually becomes narrow during beam propagation. The interference pattern may have various widths according to a length of the MMI coupler 120. The length of the MMI coupler 120 may be adequately selected. The MMI coupler 120 may have an input width Wst of about 5 um.

In a structure used for the computer simulation, an input width Win of the first tapered part is about 2.5 um, an output width Wtp of the first tapered part is about 3.5 um, an input width Wst of the MMI coupler is about 7 um, and an output width Wfin of the MMI coupler is about 4.5 um. Lengths at points a, b, c, and d of the MMI coupler are defined as follows: z=0 um, z=207 um, z=217 um, and z=225 um, respectively.

When the MMI coupler 120 has an input width Wst of less than about 3 um, it is difficult to cause actually good MMI. Also, when the MMI coupler 120 has an input width Wst of greater than about 10 um, it is difficult to realize a desired MMI because the MMI coupler 120 has a short mode change period. When the input width Wst the MMI coupler 120 increases, a distance between modes formed in the MMI coupler 120 is widened to increase a ripple.

In the tapered MMI coupler 120, the mode width formed in the MMI coupler 120 may be varied in a longitudinal direction (z-axis direction). Thus, a length corresponding to a width of the MMI coupler 120 that may obtain the flat transmission characteristic may be adequately selected. In the optical device according to an embodiment, a flat transmission band width may be realized without modifying a structure of a multiplexer.

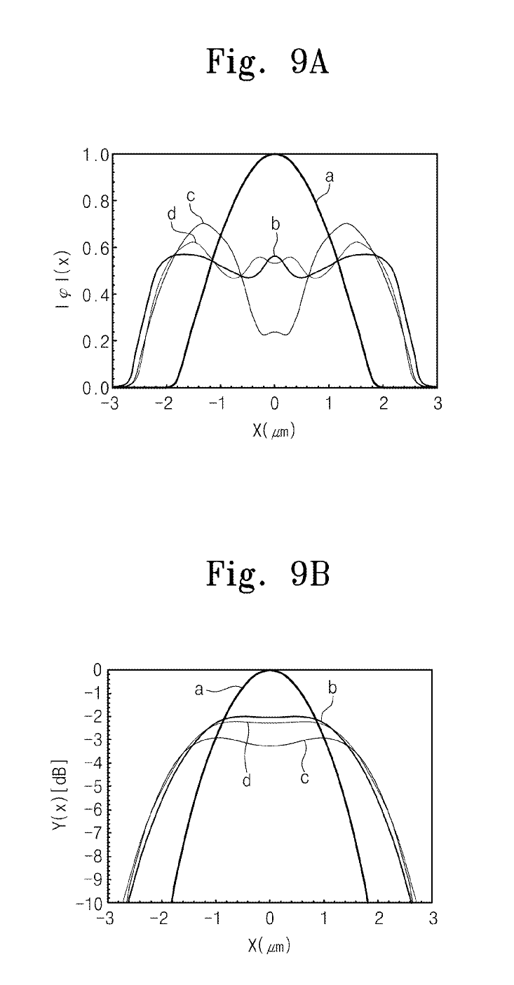

FIGS. 9A and 9B are computer simulation results illustrating characteristics at points a, b, c, and d of FIG. 8C.

FIG. 9A illustrates an absolute value Φ_{a, b, c, d}(X) of an optical intensity in a transverse direction at the points a, b, c, and d. FIG. 9B illustrates transfer characteristics Y(x) at an output point of a multiplexer according to an MMI coupler having lengths at the points a, b, c, and d.

Referring to FIGS. 9A and 9B, the transfer characteristic Y(x) at the point b shown a peak value of about −2 dB. The transfer characteristic Y(x) at the point d shown a flat-top characteristic of a peak value of about −2.3 dB. The transfer characteristic Y(x) at the point c shown a peak value of about −3 dB.

The optical device according to the inventive concept provides an optical device having the flat transmission characteristic. The optical device may include the tapered MMI coupler disposed at the input end of the multiplexer/demultiplexer to have the flat transmission characteristic. The mode width formed in the MMI coupler is variable in a longitudinal direction. Thus, the flat transmission characteristic may be obtained by adequately selecting the length of the MMI coupler.

When the width of the input waveguide of the MMI coupler is tapered, the optical device may reduce width dependence of the input waveguide to provide a stable flat transmission characteristic. Thus, the optical device may realize the flat transmission band width without modifying a structure of the multiplexer/demultiplexer.

A distance between the output optical modes of the MMI coupler may be changed according to an inclination of the tapered part of the MMI coupler. The optical device may realize superior flat transmission band and improve reliability of the device during the manufacturing process. The optical device is very effective in a structure having a high refractive index difference and a structure having a narrow input waveguide width.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. An optical device comprising:
a multiplexer/demultiplexer splitting optical signals having a plurality of channels and received through a first port according to their wavelength to provide the split optical signals to second ports, or providing input optical signals having wavelengths difference from each other and received through the second ports to the first port;
a multimode interference (MMI) coupler connected to the first port;
a first waveguide connected to the MMI coupler; and
second waveguides connected to the second ports,
wherein the MMI coupler has a width decreasing toward the multiplexer/demultiplexer.

2. The optical device of claim 1, wherein the first waveguide comprises a first tapered part having a width increasing toward the MMI coupler.

3. The optical device of claim 1, wherein the second waveguide comprises a second tapered part having a width increasing toward the multiplexer/demultiplexer.

4. The optical device of claim 1, wherein the MMI coupler and the first waveguide have the same vertical structure.

5. The optical device of claim 1, wherein the multiplexer/demultiplexer comprises an arrayed waveguide grating or a waveguide type concave grating.

6. The optical device of claim 1, wherein the MMI coupler is connected to the first port in a region in which a second multimode pattern is formed.

7. The optical device of claim 1, wherein the MMI coupler has an input width of about 3 um to about 10 um.

8. The optical device of claim 1, wherein the MMI coupler is symmetrical in a width direction.

9. The optical device of claim 1, wherein the width of the MMI coupler is continuously changed in a longitudinal direction.

10. The optical device of claim 1, wherein the width of the MMI coupler is linearly changed in a longitudinal direction.
